(19) United States
(12) Patent Application Publication
(10) Pub. No.: US 2014/0334693 A1
(43) Pub. Date: Nov. 13, 2014

(54) System and method for authenticating a photograph

(71) Applicant: Gregory Noe, Montreal (CA)

(72) Inventor: Gregory Noe, Montreal (CA)

(21) Appl. No.: 14/117,260

(22) PCT Filed: May 14, 2012
(86) PCT No.: PCT/CA2012/000461

§ 371 Date: Jul. 29, 2014

Related U.S. Application Data
(60) Provisional application No. 61/485,424, filed on May 12, 2011.

(51) Int. Cl. G06K 9/00; G06K 9/62

(52) U.S. Cl. CPC G06K 9/00483; G06K 9/00288; G06K 9/6215
USPC 382/112

(57) ABSTRACT

A novel method and a supporting system for authenticating a photograph are provided. The method for authenticating a photograph generally comprising steps for authenticating a photograph with a certifying server, typically including downloading a picture-taking software, taking at least two digital photographs of a user, comparing the at least two photographs, generating a certified photograph, and providing a link to access the certified photograph.

### CROSS-REFERENCES TO RELATED APPLICATIONS

The present patent application claims the benefits of priority of commonly assigned U.S. Provisional Patent Application No. 61/485,424, entitled “System and Method for Authenticating a Photograph” and filed at the United State Patent and Trademark Office on May 12, 2011.

### FIELD OF THE INVENTION

The present invention generally relates to systems and/or methods for authenticating photographs. More specifically, the present invention relates to systems and/or methods for authenticating portrait photography for identity certification and user security.

### BACKGROUND OF THE INVENTION

In the last years, the Internet has evolved to ease social exchanges through new means such as social networks, discussion groups or dating sites. These social tools have many advantages, such as meeting new people, keeping track of relationships or finding old schoolmates.

Unfortunately, hitherto, there is no way of verifying the veracity of the identity of the person or that an account is indeed associated to a real physical person. The lack of an authentication process has several consequences, one of the most detrimental being the risk of a person using a fake identity. For instance, on a social or dating site, a user may pretend being another person by using a fake photograph. Thus, currently, other users have no way of determining the validity of such photographs other than by trusting that the operator of the social or dating site has a manual authentication process.

Hence, there is a need for a method and/or a system for automating the authentication or the certification of users' photographs.

### BRIEF DESCRIPTION OF THE DRAWINGS

The above and other aspects, features and advantages of the invention will become more readily apparent from the following description, reference being made to the accompanying drawings in which:

FIG. 1A is a workflow diagram presenting the steps of an embodiment of a method for authenticating a photograph in accordance with the principles of the present invention.

FIG. 1B is a workflow diagram presenting the steps of another embodiment of a method for authenticating a photograph in accordance with the principles of the present invention.

FIG. 2 is a diagram of the different actors of the system and method for authenticating a photograph in accordance with the principles of the present invention.

FIG. 3 is a system diagram of an embodiment of a system for authenticating a photograph in accordance with the principles of the present invention.

FIG. 4 depicts an example of a photograph having been certified through the method and system for authenticating a photograph in accordance with the principles of the present invention.

### DETAILED DESCRIPTION OF THE PREFERRED EMBODIMENT

Novel system and method for authenticating a photograph will be described hereinafter. Although the invention is described in terms of specific illustrative embodiments, it is to be understood that the embodiments described herein are by way of example only and that the scope of the invention is not intended to be limited thereby.

The preferred embodiments of the present invention are described below with reference to the drawing figures where like numerals represent like elements throughout.

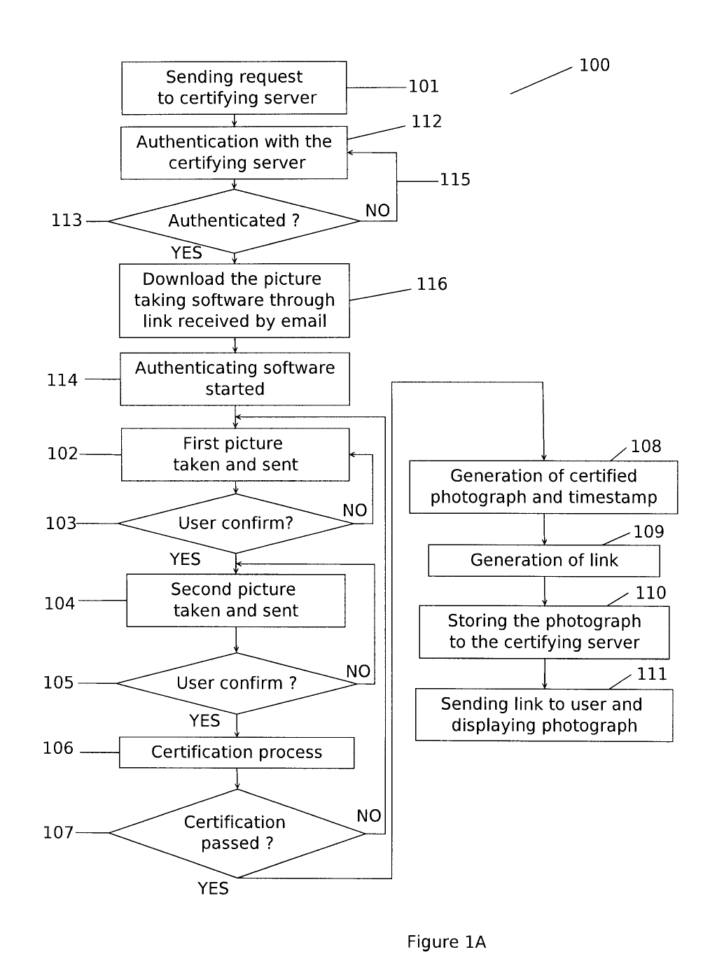

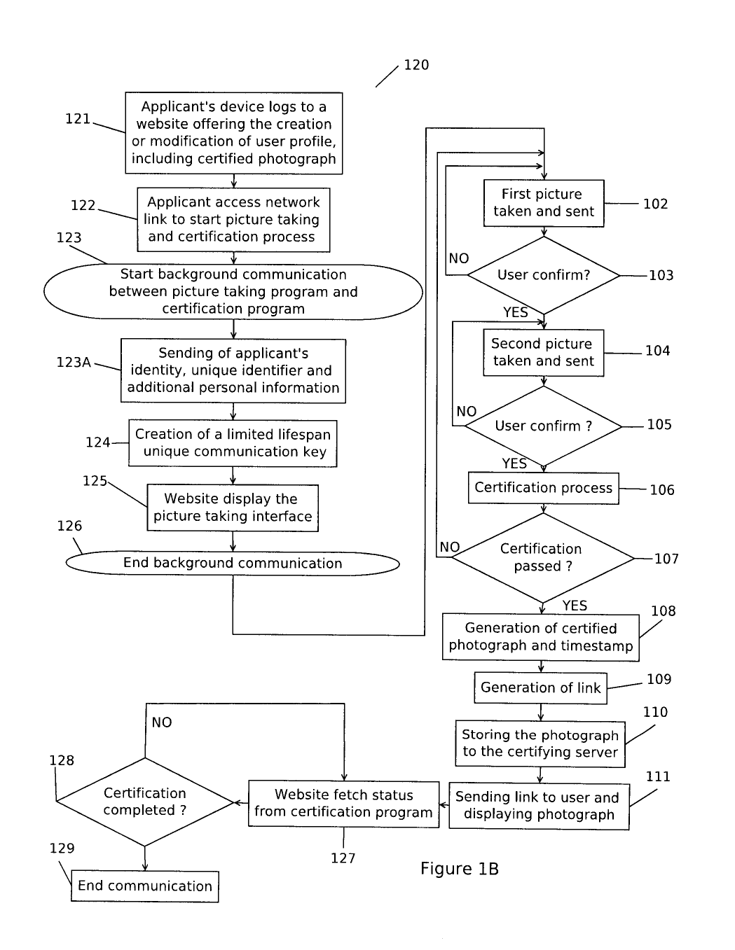

Referring to FIG. 1A, a method for authenticating a portrait photograph by ensuring the live presence of a human being is shown.

The method 100 may include a step allowing an applicant (i.e. a physical person, a human being), through a device comprising a camera or picture-taking device, to connect to a certifying server 101.

The applicant, through a device, such as computer (e.g. desktop computer, laptop computer, etc.) or a network device, such as a smart phone, a mobile phone or an intelligent tablet, comprising a program, such as a web browser or an application, sends a request over a computer network, such as the Internet or a local area network, to connect to the server 112. Such request may be implemented as a HTTP request through a web service and shall preferably include a unique identifier such as the email address of the applicant. On reception of the request, the server authenticates the applicant's device 112.

To authenticate the applicant 112, the server may send a notification to the applicant email address, such notification including a unique network link, such as a Uniform Resource Locator (URL), used to verify the applicant's email address.

Shall the authentication 112 be successful, the applicant shall click on the network link to request a verification to the server. The server then sends a response to the applicant's device including a forwarding network link 114. Such forwarding link may, through network communication software such as a web browser software installed on the applicant's device, open a web page on a certification website which allow a picture-taking software program to be downloaded. Such software includes a function for taking digital pictures and may be started automatically upon downloading. In another embodiment, such picture-taking program may be implemented as a software as service such as a web-based application or a cloud-based application. In still other embodiments, the picture-taking software could be already present on the applicant's device such that no download would be necessary.

In the case of an unsuccessful authentication 115, the server sends a response over the computer network denying the access to the server.

Once the connection is established, as mentioned above, between the applicant's device and the server 114, the picture-taking program invites the applicant to take a photograph using the camera of the applicant's device. Such photograph shall include a significantly identifying part of the applicant's body, preferably the face. A live output of the camera on the applicant's device may be displayed in the interface of the applicant's device to allow the applicant to adjust the parameters of the camera or its posture. When ready, the applicant takes a first photograph. The taking of the photograph may be facilitated by the use of a face detection algorithm. The picture-taking program may ask the user to take a photograph in a specific posture. Once taken, the first picture is displayed in a section of the interface of the applicant's device.

The first photograph being taken 102, the picture-taking program may, via the applicant's device's interface, ask the applicant to confirm the approbation of the photograph taken 103. The applicant must accept or reject the photograph by inputting his/her answer via the applicant's device's interface. In the event of the applicant rejecting the photograph, step 102 is repeated and a new first photograph must be taken.

Once the first photograph is accepted by the applicant 103, the picture-taking program shall, via the applicant's device's interface, prompt the applicant to take a second photograph of the same significantly identifying part of his/her body, preferably the face 104. The process of taking the second photograph repeats the process from the step 102, except that the picture-taking program may ask the applicant to take the second photograph, so that, although similar to the first photograph, the photograph shall differ from said first photograph within a certain ratio of difference, to be determined by the picture-taking program. The differences may be introduced, for example, by adopting a specific posture that is different from the posture from step 102 (e.g. raising one hand, tilting the head, etc.).

Similarly to the taking of the first photograph 102, the picture-taking program may, via the applicant's device's interface, ask the applicant to confirm that he/she approves the second photograph taken 105. The applicant must accept or reject the second photograph by inputting his/her answer via the applicant's device's interface. In the event of the applicant rejecting the photograph, step 104 is repeated and a new second photograph must be taken.

In another embodiment, both steps of taking another photograph 104 and confirming the photograph 105 may be repeated a plurality of times in order to take more than two photographs. All images taken may be stored on a plurality of storing devices of the client device such as random access memory (RAM) or physical hard disk, on the certifying server, or on a remote networked storing device (e.g. cloud-based storing device or service).

The steps of taking and confirming the first and second photographs (steps 102, 103, 104 and 105) must generally be performed within a predetermined amount of time. The predetermined amount of time is typically at most five minutes, preferably at most two minutes, and most preferably at most one minute.

Once all photographs have been taken 102 and 104 and approved 103 and 105 by the applicant, the picture-taking program sends the taken pictures to the server via a file transferring protocol such as file transfer protocol (FTP) or hypertext transfer protocol (HTTP) through the computer network, to establish a certification session with the server and start the certification process of the photographs.

On reception of the photographs, the server shall, through the execution of a resident certification program, certify that a human being is present in the photographs 106.

As mentioned above, the photographs taken by the picture-taking program are explicitly slightly different in order to assure that a real physical person is indeed behind the camera.

The certifying process 106 generally involves the comparison of the two photographs in order to determine if the two photographs are similar enough, yet non-identical, to be authenticated.

Several methods can be used to determine the appropriate level of similarity between the two photographs.

In one embodiment, the certifying process 106 compares all the pairs of corresponding pixels contained in the received photographs. In other words, the certifying process 106 determines if pairs of pixels respectively located at the same position in each photograph are substantially of the same color. During the execution of certifying process 106, the server calculates the number of substantially identical pairs of corresponding pixels in the photographs. In order to successfully complete the photograph certification process and issue a certified photograph, the number of substantially identical pairs of corresponding pixels between all the photographs must be equal or greater to a specific threshold of substantially identical pairs of corresponding pixels (i.e. first threshold). Additionally, the number of substantially different pairs of corresponding pixels between all the photographs must be equal or greater than a specific threshold of substantially different pairs of corresponding pixels (i.e. second threshold).

It has been found that, in order to optimize the certification method provided herein, the number of substantially identical pairs of corresponding pixels between the photographs must be equal or greater to a specific threshold. In one specific embodiment, a threshold of at least 60% of substantially identical pairs of corresponding pixels has been found adequate to certify the photographs. At the same time, it has been found that, in order to optimize the certification method provided herein, the number of substantially different pairs of corresponding pixels between the photographs must be equal or greater to a specific threshold. In this specific embodiment, a trigger of at least 15% of substantially different pairs of corresponding pixels has been found adequate to certify the photographs.

In another embodiment, the comparison process first identifies a predetermined amount of colors (e.g. 25 colors, 50 colors, etc.) which are more frequently found in each photograph. Then, the comparison process determines whether the most frequent colors are substantially the same in both photographs. If the most frequent colors are substantially the same (e.g. more than 80%) in both photographs, then the certifying process 106 will certified the photograph.

Understandably, the certifying process 106 can be performed on only one or more portions of the photographs or on a subset of the pixels. For instance, the comparison may be performed with discrimination between the background and the head/face area present in the photographs. The comparison may also involve a subdivision of the photographs in several subsections for segregated comparisons.

For example, in yet another embodiment, through the use of a face detection algorithm (e.g. such as the one made available by the company Face.com), the comparison process first creates two subsets of pairs of photographs, the first subset being a pair of photographs identical to the two photographs of the user taken as described above, where the faces identified by the algorithm are covered by a blank rectangle, and the second subset being the pair of photographs consisting of the two rectangle photos comprising the two faces that have been cut out of the original photographs. The comparison process then compares the two photographs of the first subset, using the most frequent color palette comparison described above, requiring a result above the first threshold (i.e. the threshold of similarity). In an embodiment, such first threshold of similarity is established at 90%. The comparison process then compares the two photographs of the second subset, using the most frequent color palette comparison process described above, requiring a result above the second threshold (i.e. the threshold of dissimilarity). In an embodiment, such second threshold is established at 20%. In yet another embodiment, a further criterion may be introduced in the comparison process of the above embodiments, where it is required that the ratio of the surfaces of the two rectangles comprising the two faces that have been cut out to the total surfaces of the original photographs be within a certain bracket. In an embodiment, such bracket has been determined to be between 15% and 25%.

The certifying process 106 can also perform some adjustments (e.g. redimensioning, cropping, etc.) to take into account the size of the head/face surface relative to the background. For example, it may be necessary to adjust such ratio when using a mobile device, such as a mobile phone or a tablet, given the increased possibility of a different background. In such circumstances, the use of a face detection algorithm may be relevant, mostly for such mobile devices.

If the certification process 106 fails, the server sends an invalidation response to the applicant's device 107. The applicant's device notifies the unsuccessful authentication to the applicant through a notification such as a message displayed by the picture-taking program, or an email message sent by the server to applicant at his/her email address. The notification indicates that the certification process must be restarted. At this point, the process is restarted from step 102.

In the event of a successful certification 107, the server generates a certified photograph 108. Typically, the certified photograph is a single image file of one of the photographs which has been selected, either randomly or at the choice of the applicant, containing, as an inlay, in smaller size, one or more of the other photograph(s).

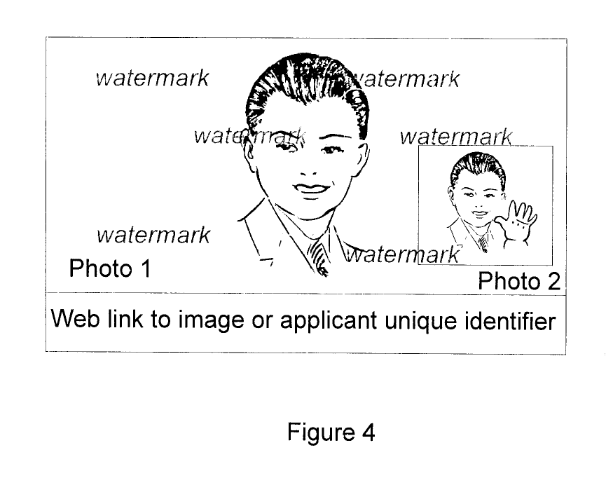

In the present embodiment, the server assigns the applicant's email address to the certified photograph and may create a link such as an URL to access the certified photograph from a remote device 109. The certified photograph may comprise the selected photograph taken as background and the other photograph(s) taken as thumbnail over the selected photograph. As shown in FIG. 4, the certified photograph may also comprise the link and/or the applicant's email address, and one or more watermarks. The watermark may indicate the name of the site or of the provider of the certifying method, the unique identifier of the photograph and the date when the photograph was stored on the server. The certified photograph may also be linked to a QR code, allowing a direct connection to the link such as the above mentioned URL to access the certified photograph from the remote device 109.

It may also, at the request of the applicant, be associated with other applicant's personal information, including personal address, telephone number, employer's name, credit card number, etc.

The certified photograph may be stored on the server in a data source such as a database or in a file such as an image file 110.

The certified photograph contained at least one protection mechanism against identity theft. For instance, the stored photograph allows users or programs to certify that the same photograph displayed on a web site or received by email is genuine. Other security mechanisms may be added or implemented to certify to third parties that a photograph is genuine.

Concurrently or subsequently, the certified photograph is sent to the applicant's device via a file transferring protocol such as file transfer protocol (FTP) or hypertext transfer protocol (HTTP) through the computer network. On reception of the certified photograph, the applicant's device may display the photograph through the interface of the applicant's program, such as in the case where the applicant's device is a mobile device, or on the user Internet browser, such as in the case where the applicant's device is a computer, where the certified photograph would be pulled out of an application such as a Flash® application and displayed on a standard webpage.

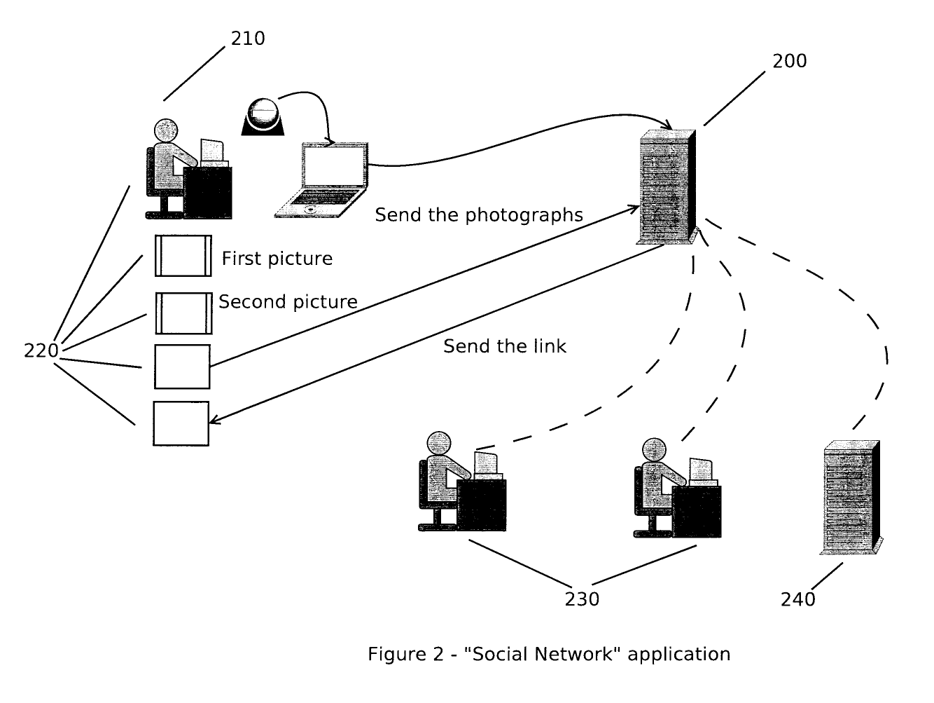

Now referring to FIG. 2, an example of an application of the present invention is shown through an interaction diagram. The first interaction must be from an applicant 210. The applicant 210 must follow the hereinabove described steps 220 to create a certified photograph on the server 200. The server 200 may comprise a web server offerings functions to retrieve certified photographs from applicants 210. The web server may be part of the same physical machine of the server or may be located on a separated physical machine.

Once stored on the server 200, the certified photographs may be accessed by third parties such as external users 230 or external computer devices 240 which may include web servers or applications, network robots or any other software or hardware program. To this end, the server's website 200 may comprise a search box that allow a third party 230 or 240 to search for a certified photograph of any applicant 210 using, as reference, the applicant's 210 unique identifier, such as an email address or a user identifier, as input. The use of a unique identifier, such as an email address, to link the certified photograph to an applicant 210 simplifies the access or the retrieval of a certified photograph.

Alternatively, an applicant who had his/her photograph certified following the hereinabove described steps may send the certified photograph to a third party 230 or 240 from the email address associated with the certified photograph. Then, the third party 230 or 240 may proceed to a simple verification by comparing the email address of the sender and the email address associated with the certified photograph.

Another alternative includes using the last photograph certified in association with the applicant's 210 email address.

Also, if any third party 230 or 240 searches on the certification website 200 for a certified photograph in association with the unique identifier of an applicant 210 and founds no result, the server can automatically send a notification such as an email message to the person associated to the unique identifier looked for. Such notification may propose to such person to complete the hereinabove described steps 220 for obtaining a certified photograph.

Referring now to FIG. 1B, in a second embodiment of the present invention, the method 120 may include a step allowing the applicant, through a similar applicant's device, to log through an Internet browser program residing on the applicant's device, to a website, such as a social network or a dating website, based on a second server, offering the creation or modification of a user's site profile, which includes a certified photograph 121.

The method may comprise a step proposing to the applicant a network link such as an URL to a page of the website of a first server that initiates the picture-taking and certification method 122. Such picture-taking and certification method shall comprise the steps from step 103 to step 111 of the method described in the previous embodiment, as illustrated in FIG. 1A. However, in the second embodiment, the method may include the first step of opening a communication protocol, as a background task, establishing a connection between the second server and the certification program located on the first server 123. Such protocol may comprise a step including the sending by the applicant's device of a notification containing the name of the website as well as other information such as the applicant's identity, unique identifier used within the website and any other additional personal information allowing the identification of the applicant 123A.

Then, the certification program may record the information received from the picture-taking program related to the applicant and the applicant unique identifier, create at least one unique communication key to be used during the data exchange process, and may send the communication key to the second server 124. To ensure a high level of security, such communication key shall have a limited life time. Such life time shall be fixed or configurable in order to allow enough time for an applicant to successfully complete the picture-taking and certification process. Typically, a length of a few minutes should be sufficient. A delay of 5 minutes, and preferably 2 minutes has been found to be satisfactory. Other delay are however possible.

The page from the website based on the second server may provide a mechanism to download the picture-taking program on the applicant's device and run the picture certification program within a normal or a modal window such as a “POPUP” type or a “IFRAME” type. The type of window to be used shall be comprised within the communication key. Then, the first server or the applicant's device shall end the communication protocol between the picture-taking program and the certification program 126.

The applicant may then go through and complete the method described in the herein first embodiment to certify a photograph from step 102 to step 111. The certified photograph is generated and stored on the first server. Concurrently, the additional personal information is associated to the certified photograph and stored on the first server.

The method may then include the step of fetching the status of the photograph certification process from the certification program of the first server 127. A plurality of status may be returned from this step, such as a status identifying the process as completed, as still processing or as standby. Such status fetching step may be done through background task initiating and maintaining a communication protocol using the communication key from the website of the second server.

Once the certification process is completed 128, the certification program shall generate and return to the website of the second server a unique applicant's certified picture identifier 129.

The website of the second server could also initiate a connection with the certification program of the first server using the OAuth open authorization protocol.

Should the first server and second server be the same, then there would be no need to introduce both communication protocols.

Typically, when the certification process is completed by the applicant, the certified photograph shall be available on the website offering the creation or modification of a user's site profile. Additionally, the website shall include the certified photograph, including the unique identifier, within the certified photographs accessible to any third party visiting the website. Any third party may proceed to a simple verification by comparing the unique identifier given on the website to the identifier associated with the certified photograph.

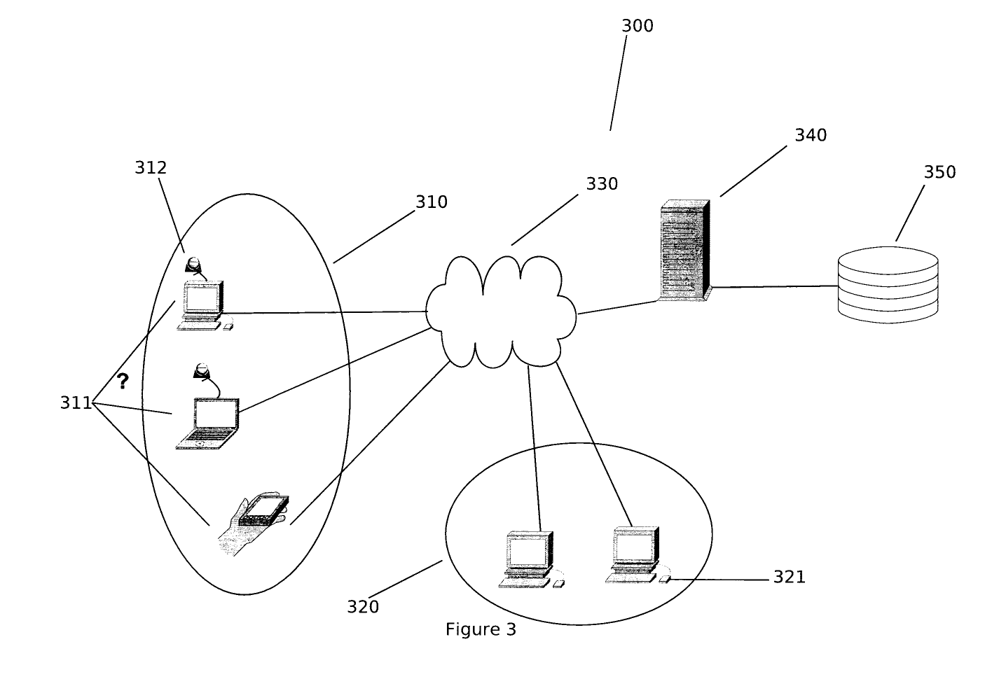

Now referring to FIG. 3, a system for authenticating a photograph 300 is presented. The system comprises a plurality of network devices 311 such as computer, mobile device or smart phone having a picture-taking device 312 such as a web camera, a wide area network 330 such as the Internet, at least one server 340, at least one data source 350 such as a database and a plurality of network devices 321 using the system to retrieve one or more certified photograph.

The network devices 311 connects to a server 340 through the wide area network 330 in order to have a photograph authenticated following the method described hereinabove. A server 340 stores and retrieves the certified photographs in at least one data source 350. A server 340 and a data source 350 may be interchangeably located on a plurality of physical machine or a single physical machine. A network device 321 willing to retrieve a certified picture connects to the server 340 through the wide area network 330. A network device may be operated by a physical person or by a computer controlled device such as a web service or an application programming interface (“API”).

Understandably, though the present embodiments of the present invention have been described in the context of bi-dimensional photographs, they could also be applied to tri-dimensional photographs.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) (canceled)

2) (canceled)

3) (canceled)

4) (canceled)

5) (canceled)

6) (canceled)

7) (canceled)

8) (canceled)

9) (canceled)

10) (canceled)

11) (canceled)

12) (canceled)

13) (canceled)

14) (canceled)

15) (canceled)

16) (canceled)

17) (canceled)

18) (canceled)

19) (canceled)

20) (canceled)

21) (canceled)

22) A method for authenticating a digital photograph of a person, the method comprising:
a) receiving at least a first digital photograph and a second digital photograph of the person, the at least first and second digital photographs having been taken within a predetermined amount of time, the at least first and second digital photographs comprising at least an identifying portion of the person, and the at least first and second digital photographs being different;
b) determining a level of similarity between the first and second photographs;
c) as a function of the level of similarity, authenticating, or invalidating, the at least first and second digital photographs of the person.

23) A method as claimed in claim 22, wherein the at least identifying portion of the person comprises the face of the person.

24) A method as claimed in claim 22, further comprising generating an authenticated digital photograph based on at least one of the first and second digital photographs.

25) A method as claimed in claim 24, wherein the authenticated digital photograph comprises one of the first and second digital photographs as a main photograph, and the other of the first and second digital photographs as an inlay within the main photograph.

26) A method as claimed in claim 22, wherein the determining of the level of similarity comprises determining at least one of a first number of substantially identical pixels between the first and second digital photographs, and a second number of substantially different pixels between the first and second digital photographs.

27) (canceled)

28) (canceled)

29) A method as claimed in claim 26, wherein the at least one of the first and second numbers is determined by comparing at least a subset of the pixels of the first and second digital photographs.

30) A method as claimed in claim 26, wherein authenticating the first and second digital photographs comprises comparing the first number to a first predetermined threshold number, and/or comparing the second number to a second predetermined threshold number.

31) (canceled)

32) (canceled)

33) A method as claimed in claim 22, wherein the determining of the level of similarity comprises determining the most frequent colors in the first digital photograph, and determining the most frequent colors in the second digital photograph, and determining a number of common colors in the most frequent colors in the first digital photograph and the most frequent colors in the second digital photograph.

34) A method as claimed in claim 33, wherein authenticating the first and second digital photographs comprises comparing the number of common color to a predetermined threshold.

35) (canceled)

36) A method as claimed in claim 24, further comprising associating at least one unique identifier to the authenticated digital photograph.

37) (canceled)

38) (canceled)

39) (canceled)

40) A method for authenticating digital photographs of a person, the method comprising:
a) within a predetermined amount of time, sequentially taking a series of digital photographs of the person, the digital photographs comprising at least an identifying portion of the person, the digital photographs being different from each other;
b) comparing pairs of consecutive digital photographs and determining, for each pair, a level of similarity between the first and second photographs;
c) as a function of the level of similarity determined for each pair of consecutive digital photographs, authenticating, or invalidating, the series of digital photographs of the person.

41) A method as claimed in claim 40, wherein the at least identifying portion of the person comprises the face of the person.

42) A method as claimed in claim 40, further comprising generating an authenticated digital photograph based on at least one of the digital photographs.

43) A method as claimed in claim 42, wherein the authenticated digital photograph comprises one of the digital photographs as a main photograph, and at least another one of the digital photographs as an inlay within the main photograph.

44) A method as claimed in claim 42, further comprising storing the authenticated digital photograph on a server.

45) A method as claimed in claim 44, further comprising providing a link to access the authenticated digital photograph.

46) A method as claimed in claim 40, wherein the determining of the level of similarity between each pair of consecutive digital photographs comprises determining at least one of a first number of substantially identical pixels between the pair of consecutive digital photographs, and a second number of substantially different pixels between the pair of consecutive digital photographs.

47) (canceled)

48) (canceled)

49) A method as claimed in claim 46, wherein the at least one of the first and second numbers is determined by comparing at least a subset of the pixels of the pair of consecutive digital photographs.

50) A method as claimed in claim 46, wherein authenticating the series of digital photographs comprises comparing each of the first numbers to a first predetermined threshold number, and/or comparing each of the second numbers to a second predetermined threshold number.

51) (canceled)

52) (canceled)

53) A method as claimed in claim 40, wherein the determining of the level of similarity between each pair of consecutive digital photographs comprises determining the most frequent colors in a first digital photograph of the pair of consecutive digital photographs, and determining the most frequent colors in a second digital photograph of the pair of consecutive digital photographs, and determining a number of common colors in the most frequent colors in the first digital photograph of the pair of consecutive digital photographs and the most frequent colors in the second digital photograph of the pair of consecutive digital photographs.

54) A method as claimed in claim 53, wherein authenticating the series of digital photographs comprises comparing each number of common colors to a predetermined threshold.

55) (canceled)

56) A method as claimed in claim 42, further comprising associating at least one unique identifier to the authenticated digital photograph.

57) (canceled)

58) A method as claimed in claim 40, wherein taking the series of digital photographs is performed on a first device, and wherein comparing and authenticating the series of digital photographs are performed on a second device remote from the first device, the first and second devices being in communication via a communication network.

59) (canceled)

60) (canceled)

61) A computer device containing instructions for performing a method for authenticating a digital photograph of a person, the method comprising:
a) receiving at least a first digital photograph and a second digital photograph of the person, the at least first and second digital photographs having been taken within a predetermined amount of time, the at least first and second digital photographs comprising at least an identifying portion of the person, and the at least first and second digital photographs being different;
b) determining a level of similarity between the first and second photographs;
c) as a function of the level of similarity, authenticating, or invalidating, the at least first and second digital photographs of the person.

62) A computer device as claimed in claim 61, wherein the computer device is a server.
